(19) United States
(12) Patent Application Publication
(10) Pub. No.: US 2012/0156402 A1
(43) Pub. Date: Jun. 21, 2012

(54) PRINTING SUBSTRATE WITH INTEGRATED FRAME

(75) Inventors: Christopher J. DOMANSKI, Mocksville, NC (US); Constance HENSHAW, Milford, CT (US); Candace L. OVERCASH, Statesville, NC (US); Gail Moore NELLIS, Statesville, NC (US)

(73) Assignee: ELMER'S PRODUCTS, INC., Westerville, OH (US)

(21) Appl. No.: 13/407,351

(22) Filed: Feb. 28, 2012

Related U.S. Application Data
(63) Continuation-in-part of application No. 12/753,979, filed on Apr. 5, 2010.

(51) Int. Cl. B41M 5/00

(52) U.S. Cl. 428/32.18

(57) ABSTRACT

A substrate suitable for use with digital imaging systems such as large-scale digital flatbed printers is provided. This substrate includes a first layer that further includes a durable material suitable for receiving a printed image; a second layer that is attached to the first layer, wherein the second layer further includes a material that is different than the material of the first layer, and wherein the second layer is operative to provide structural support to the first layer. The first layer may include a variety of papers, canvas or canvas-like material, or unbleached, uncoated, high-strength paperboard. The second layer may include a substantially rigid polystyrene core or other rigid or semi-rigid material. A third layer may be attached to the second layer and may include some or all of the components of the first layer. This printing substrate may include an integrated frame for providing structural support to the substrate.

### CROSS-REFERENCE TO RELATED APPLICATIONS

This patent application is a continuation-in-part of U.S. patent application Ser. No. 12/753,979 filed on Apr. 5, 2010 and entitled “Foamboard Substrate for Use with Digital Imaging Systems” the disclosure of which is hereby incorporated by reference herein in its entirety and made part of the present U.S. utility patent application for all purposes.

### BACKGROUND OF THE INVENTION

The present invention relates generally to substrates for use with digital printers, and more specifically to a multi-layered, foam-paper substrate that is compatible with large flatbed digital printers and digital printing techniques.

Digital imaging systems are commonplace in the modern business world and such systems are frequently used both for small scale printing jobs and for printing jobs that require larger formats such as signs and displays. Prior art substrates used with digital printers are often not appropriate for printing jobs that require larger formats due to a lack of rigidity, poor finishing quality, lack of uniformity in the printing surface, or other structural or compositional deficiencies. Thus, there is a need for a larger-scale printing substrate that is compatible with large flatbed digital printers and the like.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first printing substrate for use with digital imaging systems is provided. This substrate includes a first layer, wherein the first layer further includes a durable material suitable for receiving a printed image; a second layer, wherein the second layer is attached to the first layer, wherein the second layer further includes a material that is different than the material of the top layer, and wherein the second layer is operative to provide structural support to the first layer; wherein (optionally) the first and second layers have been cut into a predetermined geometry that includes a central inner region and a plurality of outer regions surrounding the central inner portion; wherein the second layer of each of the outer regions includes at least three grooves or channels cut therein for allowing each outer region to be folded; and wherein the plurality of outer regions is operative to form a frame that is integral with the printing substrate when each outer region is folded over, inward, and onto the bottom layer and secured thereto.

In accordance with another aspect of the present invention, a second printing substrate for use with digital imaging systems is provided. This printing substrate includes a first layer, wherein the first layer further includes canvas or a canvas-like material suitable for receiving a printed image; a second layer, wherein the second layer is attached to the first layer, wherein the second layer further includes a material that is different than the material of the first layer, and wherein the second layer is operative to provide structural support to the first layer; wherein (optionally) the first and second layers have been cut into a predetermined geometry that includes a central inner region and a plurality of outer regions surrounding the central inner portion; wherein the second layer of each of the outer regions includes at least three grooves or channels cut therein for allowing each outer region to be folded; and wherein the plurality of outer regions is operative to form a frame that is integral with the printing substrate when each outer region is folded over, inward, and onto the second layer and secured thereto.

In yet another aspect of this invention, a third printing substrate for use with digital imaging systems is also provided. This printing substrate includes a first layer, wherein the first layer further includes canvas or a canvas-like material suitable for receiving a printed image; a second layer, wherein the second layer is attached to the first layer, wherein the second layer further includes a material that is different than the material of the first layer, and wherein the second layer is operative to provide structural support to the first layer; wherein (optionally), the first and second layers have been cut into a predetermined geometry that includes a central inner region and a plurality of outer regions surrounding the central inner portion; wherein the second layer of each of the outer regions includes at least three grooves or channels cut therein for allowing each outer region to be folded; and wherein the plurality of outer regions is operative to form a frame that is integral with the printing substrate when each outer region is folded over, inward, and onto the second layer and secured thereto.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is an exploded, perspective view of a first exemplary embodiment of the printing substrate of the present invention shown in the two-sided version;

FIG. 2 is an exploded, perspective view of a second exemplary embodiment of the printing substrate of the present invention shown in the two-sided version;

FIG. 3 is an exploded, perspective view of a third exemplary embodiment of the printing substrate of the present invention shown in the two-sided version;

FIG. 4 is a top view of an embodiment of this invention that has been adapted to include an integrated frame;

FIG. 5 is a bottom view of an embodiment of this invention that has been adapted to include an integrated frame, wherein a portion of the printing substrate has been folded over onto itself to create the frame;

FIG. 6A-B are side views of an embodiment of this invention that has been adapted to include an integrated frame showing the appearance of the V-shaped grooves cut into the substrate to allow the substrate to fold onto itself as well as the appearance of the substrate after the cut area has been folded over to create the integrated frame;

FIG. 7 is a top view of an alternate embodiment of this invention that has been adapted to include an integrated frame, wherein the printing substrate is pre-scored to provide a removable portion of the printable surface area that may be folded to create the integrated frame after it has been removed from the larger printing substrate;

FIG. 8 is a top view of the embodiment of FIG. 7 showing the foldable regions of the printing surface area after it has been removed from the larger printing substrate;

FIG. 9 is a bottom view of the embodiment of FIG. 7 showing the foldable regions of the printing surface area after it has been removed from the larger printing substrate;

FIG. 10 a bottom view of the embodiment of FIG. 7 showing the foldable regions of the printing surface area after it has been removed from the larger printing substrate and after two of the foldable regions have been folded over to create a partial integrated frame;

FIGS. 11A-B are side views of the embodiment of FIG. 7, showing the appearance of the V-shaped grooves cut into the substrate to allow the substrate to fold onto itself, as well as the appearance of the substrate after the cut areas have been folded over to create an integrated frame; and

FIG. 12 is a side view of an alternate embodiment of this invention, wherein the grooves cut into the substrate include a flattened portion or channel which facilitates folding of the integrated frame.

### DETAILED DESCRIPTION OF THE INVENTION

Exemplary embodiments of the present invention are now described with reference to the Figures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

As previously stated, the present invention provides a printing substrate for use with digital imaging systems such as large-scale digital flatbed printers. This substrate includes a first layer, wherein the first layer further includes a material suitable for receiving a printed image; a second layer, wherein the second layer is attached to the first layer, wherein the second layer further includes a material that is different than the material of the first layer, and wherein the second layer is operative to provide structural support to the first layer. The first layer may include glossy paper, fine art paper, fine art photo paper, canvas or canvas-like (i.e., durable and textured) material, or unbleached, uncoated, high-strength paperboard. The second layer may include a substantially rigid polystyrene core or other rigid or semi-rigid material. A third layer may be attached to the second layer and may include some or all of the components of the first layer. This printing substrate may be adapted to further include an integrated frame for providing structural support to the substrate. With reference now to the Figures, one or more specific embodiments of this invention shall be described in greater detail.

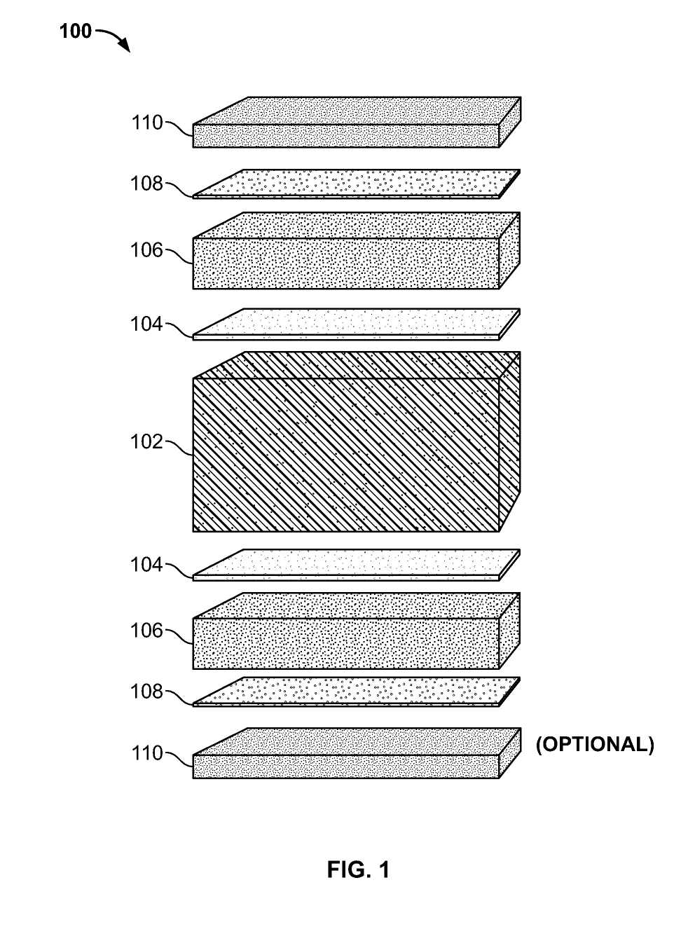

With general reference FIG. 1, the assembly and composition of a first exemplary embodiment of the printing substrate of present invention is shown. A first variant of this embodiment provides a single-sided version of the product referred to as “MightyPrint-Glossy” (Elmer's Products, Inc., Columbus, Ohio). This printing substrate includes a top layer, a middle layer, and a bottom layer. The top layer further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. Middle layer 102 is attached to the top layer further includes a white rigid polystyrene core of about 0.25 inches in thickness. The bottom layer is attached to the middle layer and further includes first component 104, which is ethylene vinyl acetate (EVA) having a thickness of about 1.25 mil; second component 106, which is 16-pt clay coated solid bleached sulphate (SBS) paper; and third component 108, which is low density polyethylene (LDPE) and binder having a thickness of about 0.7 mil. A second variant of this embodiment provides a double-sided version of the product referred to as “MightyPrint-Glossy” (Elmer's Products, Inc., Columbus, Ohio). This printing substrate also includes a top layer, a middle layer, and a bottom layer. The top layer further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. Middle layer 102 is attached to the top layer further includes a white rigid polystyrene core of about 0.25 inches in thickness. The bottom layer is attached to the middle layer and further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. FIG. 1 shows the unassembled components of the double-sided variant of this embodiment. The glossy surface or surfaces of this embodiment make the traditional time-consuming process of achieving a high gloss surface by either applying a liquid laminate or printing on a high gloss paper and mounting to a board unnecessary. In alternate versions of the first exemplary embodiment of this invention, component 110 is replaced with either fine art paper (e.g., Museo or Canon) or fine art photo paper (Canon) or any of a variety of other papers that are adapted to receive printed images, particularly images created by digital printers.

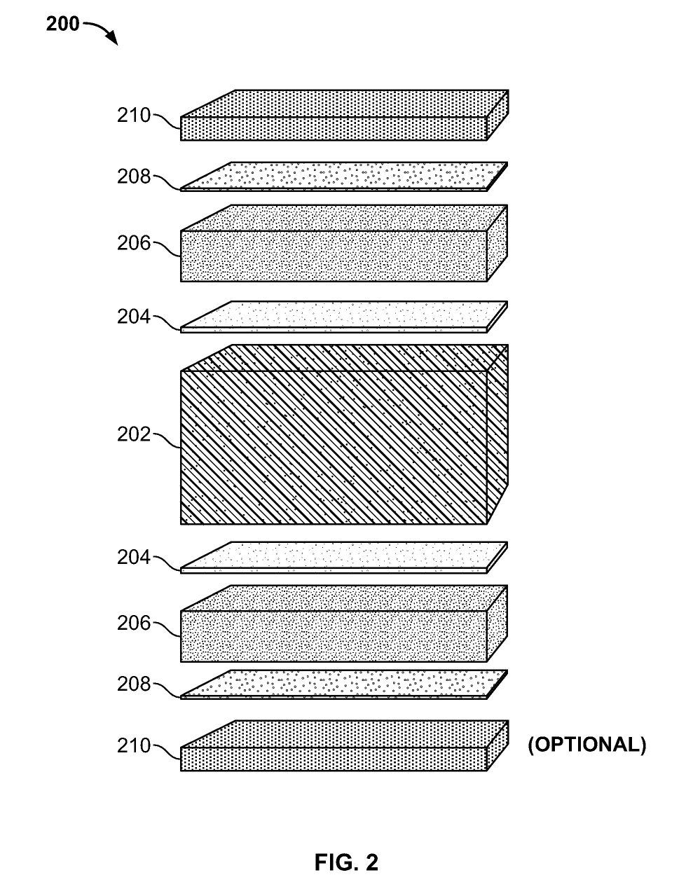

With general reference to FIG. 2, the assembly and composition of a second exemplary embodiment of the printing substrate of present invention is shown. A first variant of this embodiment provides a single-sided version of the product referred to as “MightyPrint-Canvas” (Elmer's Products, Inc., Columbus, Ohio). This printing substrate includes a top layer, a middle layer, and a bottom layer. The top layer further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. Middle layer 202 is attached to the top layer further includes a white rigid polystyrene core of about 0.25 inches in thickness. The bottom layer is attached to the middle layer and further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil. A second variant of this embodiment provides a double-sided version of the product referred to as “MightyPrint-Canvas” (Elmer's Products, Inc., Columbus, Ohio). This printing substrate includes a top layer, a middle layer, and a bottom layer. The top layer further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. Middle layer 202 is attached to the top layer further includes a white rigid polystyrene core of about 0.25 inches in thickness. The bottom layer is attached to the middle layer and further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. FIG. 2 shows the unassembled components of the double-sided variant of this embodiment. The textured surface or surfaces of this embodiment enrich and enhance the artistic qualities of printed portraits, photo-graphics and painted images. In alternate versions of the second exemplary embodiment of this invention, the Fredrix/Tara Artisan canvas is replaced with any number of different canvas or canvas-like products that are capable of receiving a printed image. Examples of such materials include products that are commercially available from a variety of sources including, but not limited to Digital Rag, Electric Quilts Printables, Art Canvas, Cotton Painter's Canvas, Belgian Linen Canvas, and Jacquard Fabrics.

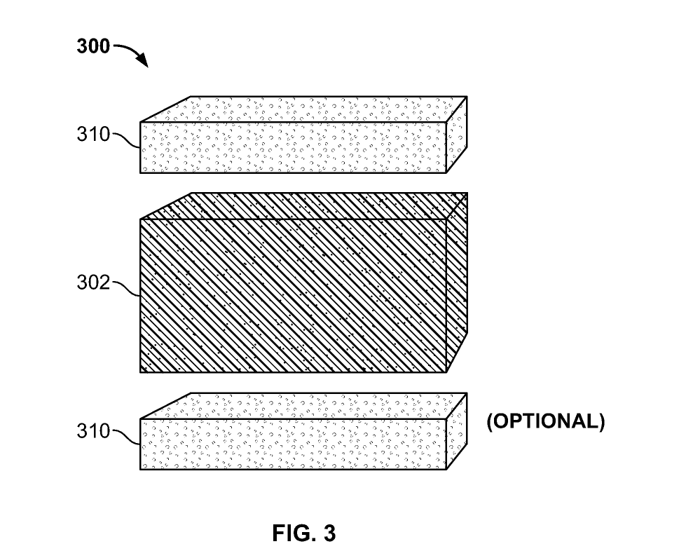

With general reference to FIG. 3, the assembly and composition of a third exemplary embodiment of the substrate of present invention is shown. A first variant of this embodiment provides a single-sided version of the product referred to as “MightyPrint-Premier Kraft” (Elmer's Products, Inc., Columbus, Ohio). This substrate also includes a top layer and a bottom layer. The top layer further includes component 310, which is unbleached, uncoated, high-strength paperboard having a weight of about 130 pounds, such as KRAFTPAK 130#. Bottom layer 302 is attached to the top layer further includes a white rigid polystyrene core of about 0.25 inches in thickness. A second variant of this embodiment provides a double-sided version of the product referred to as “MightyPrint-Premier Kraft” (Elmer's Products, Inc., Columbus, Ohio). This substrate also includes a top layer, a middle layer, and a bottom layer. The top layer further includes component 310, which is unbleached, uncoated, high-strength paperboard having a weight of about 130 pounds, such as KRAFTPAK 130#. Middle layer is 302 is attached to the top layer further includes a white rigid polystyrene core of about 0.25 inches in thickness. The bottom layer is attached to the middle layer and further includes component 310, which is unbleached, uncoated, high-strength paperboard having a weight of about 130 pounds, such as KRAFTPAK 130#. The warm undertone of this embodiment creates unique color nuances for the images being printed.

In general terms, the process for manufacturing an exemplary embodiment of the present invention includes the following components and steps. The foam component includes high heat polystyrene (HHPS) which is extruded on a large ( 6/8″) foam extruder through an annular (tubular) shaped die. The controls involved include a foam gauge mechanically controlled by a choke ring (for resisting polymer flow) and an adjustable die lip gap. Both controls can be performed on line; thus making it unnecessary to break the foam web to make any desired changes. The foam is extruded as large tube is then split into two symmetrical webs which are then thermally fused together with hot air. This heated/hot air is typically generated by natural gas burners. A fusion spline may help promote rigidity. Fusion of the symmetrical webs counteracts any circular-shaped memory in each sheet and provides a flatter, more rigid composite. Air is blown in between the two webs, and then composite web is immediately run through a series of rollers to complete bonding process. As further described below, an exemplary embodiment of the non-foam component is a composite of two papers and two adhesive layers.

Currently available products are typically saturated with undesirable chemicals such as melamine and urea formaldehyde. The exemplary embodiments of the present invention described herein include none of these chemicals. The saturation of such products also makes the paper very brittle and difficult to work with and the sharp edges and corners found thereon may require gloves for handling. MightyPrint's double adhesive layers provide an easier-to-cut board that does not suffer from these limitations. The present invention is compatible with at least the following printers: Gerber, EFI/VuTek, HP, Oce, and Gandinnovation, This invention is manufactured in a variety of finishes including glossy, matte, canvas, and photo.

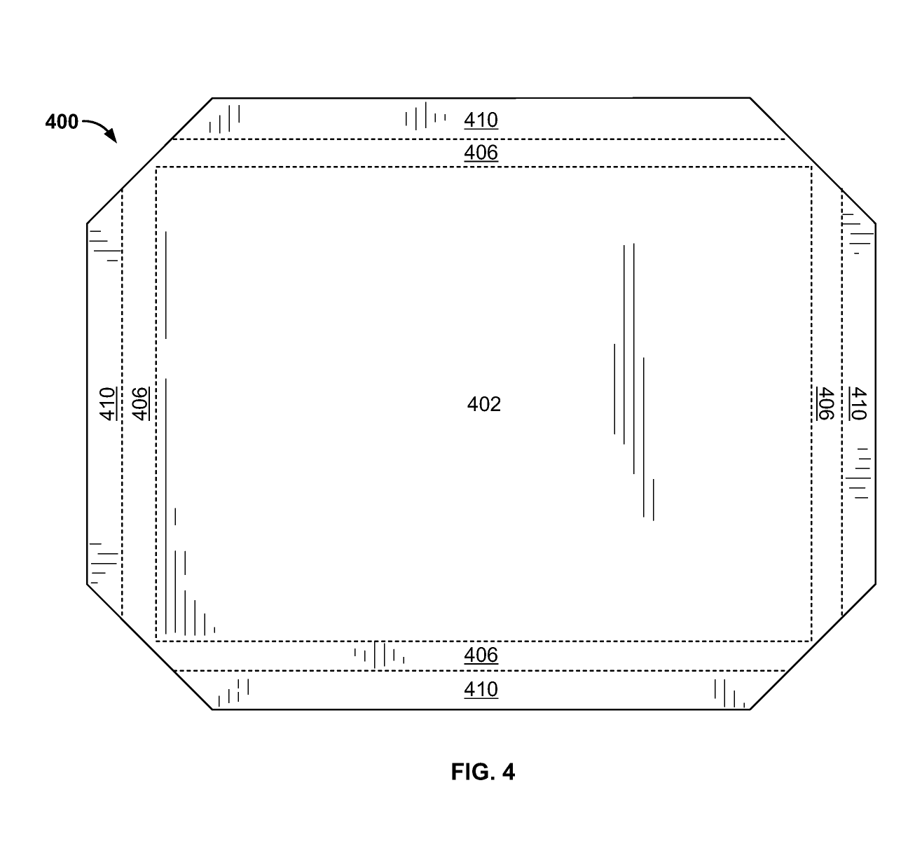

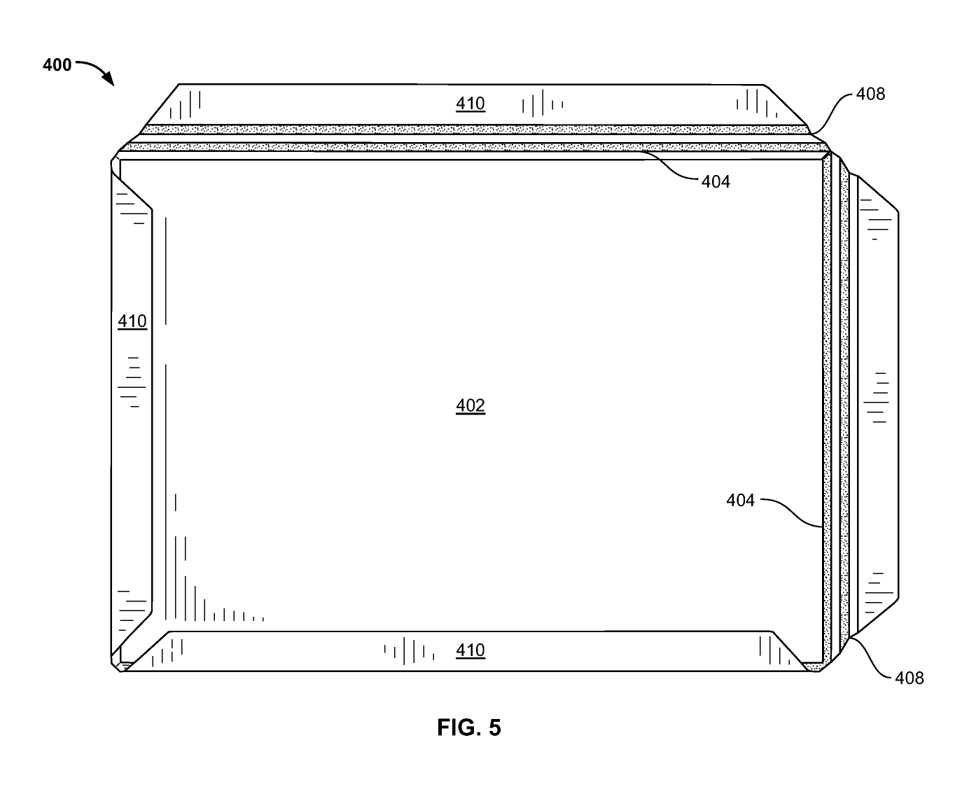

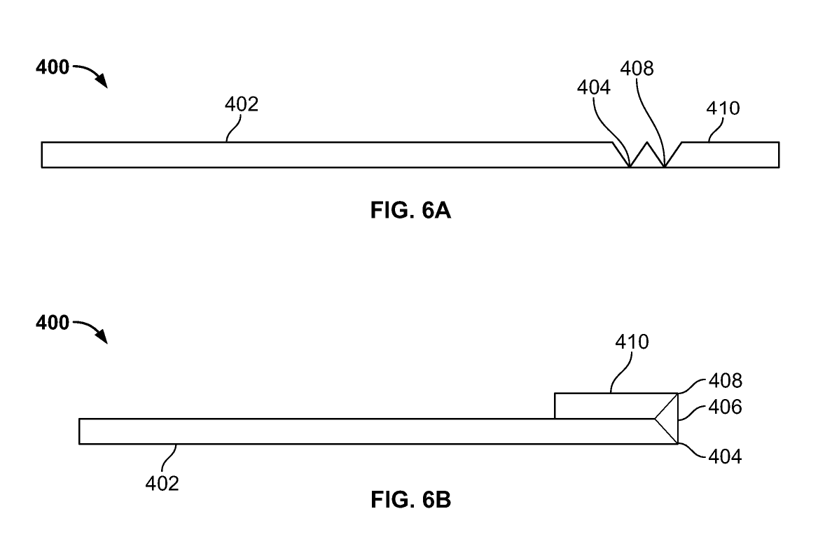

With reference to FIGS. 4-6A-B, an embodiment of this invention that has been adapted to include an integrated frame is shown. This embodiment typically involves only the single-sided versions of the present invention and is typically further limited to only the canvas-covered version of the described product, although certain non-canvas versions are compatible with this embodiment. As shown in FIG. 4, which provides a top view of printing substrate 400, interior region 402 is surrounded by four flap-like outer regions that are divided into a first section 406 and a second section 410. As shown in FIG. 5, which provides a bottom view of printing substrate 400, two adjacent roughly 90° V-shaped grooves 404 and 408 respectively are cut into the foamboard component of each of the four flap-like outer regions, but not into the canvas component or other surface component of the printing substrate. These grooves may be formed manually or by using a Zund Computerized Numeric Control (CNC) cutter or other similar device for allowing the flap-like outer regions be folded over, inward, and onto the bottom side of printing substrate 400, where they are then secured in place with glue, adhesive, or other known attachment means. In FIG. 5, the top and right flap-like outer regions remain unfolded while the left and bottom outer flap-like regions have been folded over and inward such that the upper surface of section 410 now faces outward from the bottom of printing substrate 400. FIG. 6A illustrates the geometry and placement of V-shaped grooves 404 and 408 when the flap-like regions are extended. FIG. 6B illustrates the appearance of the flap-like regions when they have been folded over and inward to create an integrated and supportive frame that surrounds interior region 402. Once assembled, this integrated frame provides significant structural support and stability to the entire printing substrate without the need to mount the printing substrate on a separate wooden frame or support of any kind prior to hanging, framing or any final finishing or treatment of an image that has been printed on the upper surface of printing substrate 400.

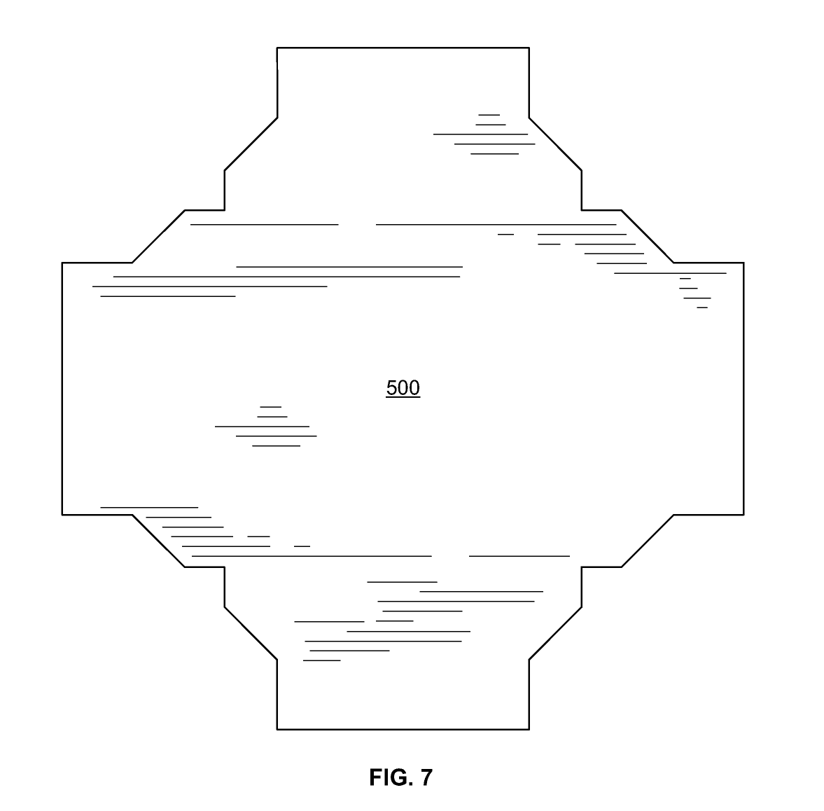

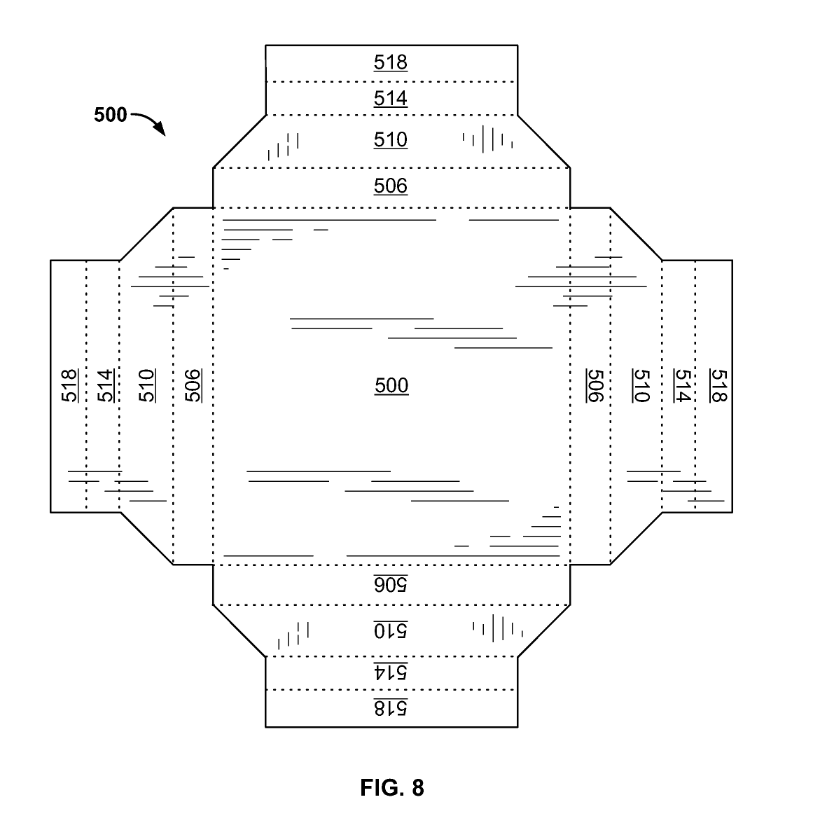

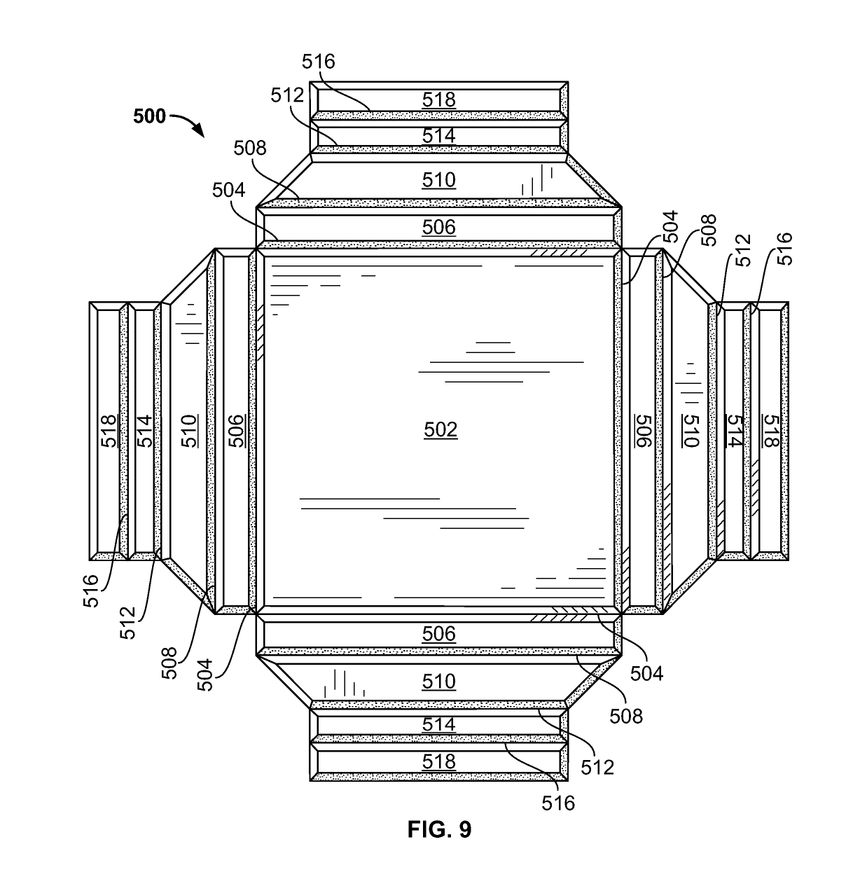

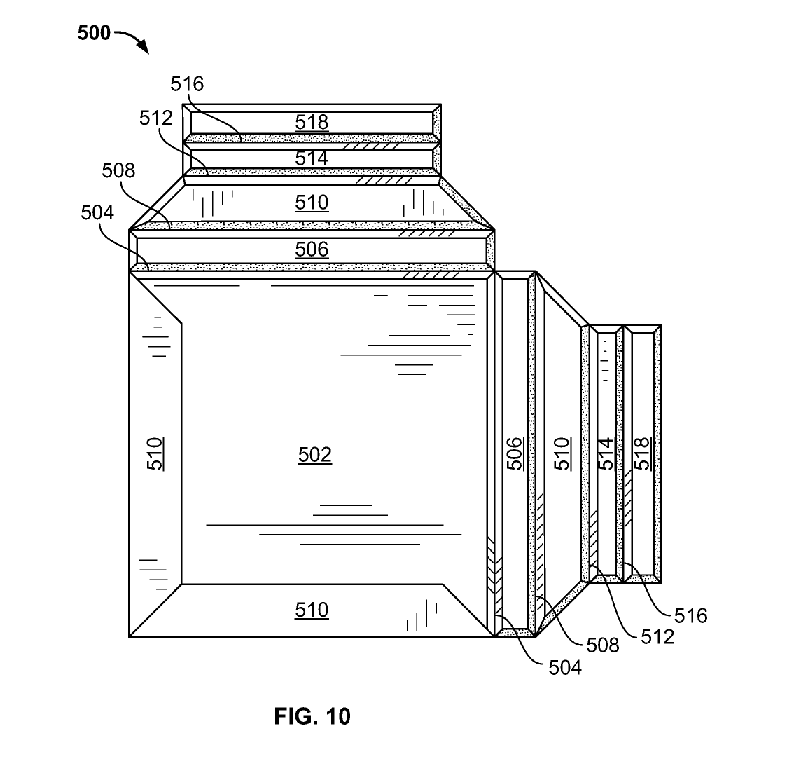

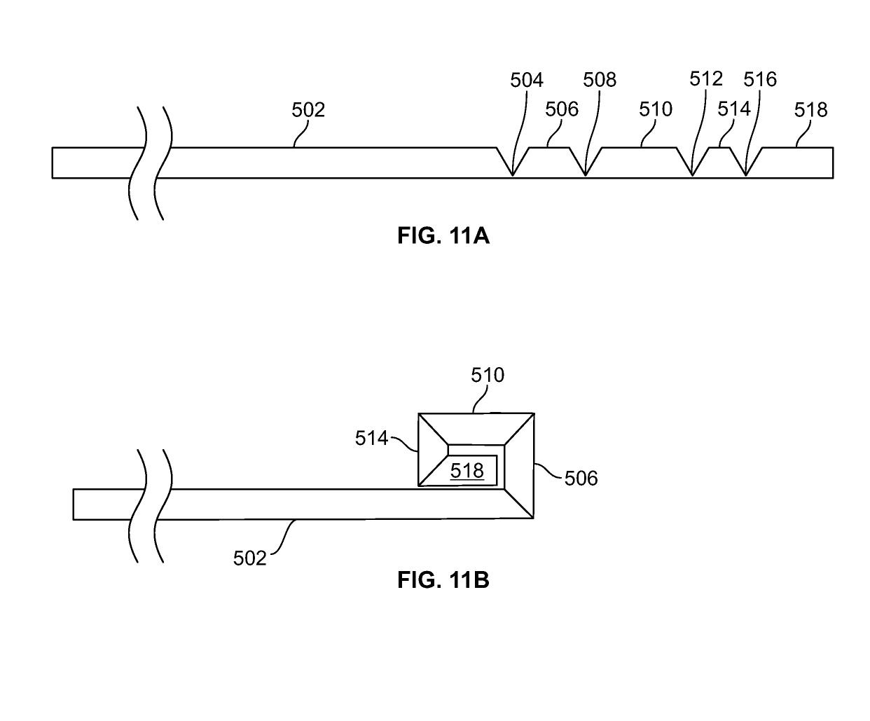

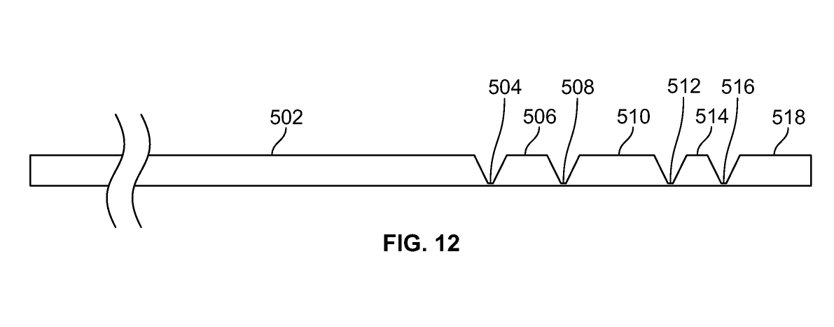

With reference to FIGS. 7-11A-B, an alternate embodiment of this invention that has been adapted to include an integrated frame is shown. This embodiment typically involves only the single-sided versions of the present invention and is typically further limited to only the canvas-covered versions of the described product, although certain non-canvas versions are also compatible with this embodiment. In some variants of this embodiment (see FIG. 7), printing substrate 500 is provided in a large square or rectangular format the has been pre-scored using a predetermined combination of V-grooves, bevel cuts, and through-cuts to permit the final configuration of the printing substrate to be punched out of the larger piece of material after an image has been printed thereon. As shown in FIG. 8, which provides a top view of printing substrate 500, interior region 502 is surrounded by four flap-like outer regions that are divided into first section 506, second section 510, third region 514, and fourth region 518. As shown in FIG. 9, which provides a bottom view of printing substrate 500, four roughly 90° V-shaped grooves 504, 508, 512, and 516 respectively are cut into the foamboard component of the four flap-like outer regions, but not into the canvas component or other surface component of the printing substrate. These grooves may be formed manually by or using a Zund Computerized Numeric Control (CNC) cutter or other similar device for allowing the flap-like outer regions be folded over and inward onto the bottom side of printing substrate 500, where they are then secured in place with glue, tape (3M), adhesive, or other known and sufficiently strong attachment means. In FIG. 10, the right and bottom flap-like outer regions remain unfolded while the left and top outer flap-like regions have been folded over and inward such that the upper surface of section 510 now faces outward from the bottom of printing substrate 500. FIG. 11A illustrates the geometry and placement of V-shaped grooves 504, 508, 512, and 516 when the flap-like regions are extended. FIG. 6B illustrates the appearance of the flap-like regions when they have been folded over and inward to create an integrated and supportive frame that surrounds interior region 502. Once assembled, this integrated frame provides significant structural support and stability to the entire printing substrate without the need to mount the printing substrate on a separate wooden frame or support of any kind prior to hanging, framing or any final finishing or treatment of an image that has been printed on the upper surface of printing substrate 500. As show in FIG. 12, in a further variant of this embodiment, the V-shaped grooves have been adapted to include a flattened bottom region that approaches or abuts the canvas or canvas-like component of the printing substrate. This flattened region results in more of a U-shaped groove or channel and facilitates folding of the integrated frame regions. This groove geometry also permits the canvas component to “breathe”, thereby reducing the likelihood that this component will crack or tear while the integrated frame is being assembled. Other groove or channel geometries are possible.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A printing substrate for use with digital imaging systems, comprising:
(a) a first layer, wherein the first layer further includes a material suitable for receiving a printed image;
(b) a second layer, wherein the second layer is attached to the first layer, wherein the second layer further includes a material that is different than the material of the top layer, and wherein the second layer is operative to provide structural support to the first layer;
(c) wherein the first and second layers have been cut into a predetermined geometry that includes a central inner region and a plurality of outer regions surrounding the central inner portion; wherein the second layer of each of the outer regions includes at least three grooves or channels cut therein for allowing each outer region to be folded; and wherein the plurality of outer regions is operative to form a frame that is integral with the printing substrate when each outer region is folded over, inward, and onto the bottom layer and secured thereto.

2. The printing substrate of claim 1, wherein the first layer further includes canvas or a canvas-like material.

3. The printing substrate of claim 1, wherein the first layer further includes low density polyethylene and binder having a thickness of about 0.75 mil; 16-18 pt base paper; and ethylene vinyl acetate having a thickness of about 1.25 mil.

4. The printing substrate of claim 1, wherein the second layer further includes a substantially rigid polystyrene core.

5. The printing substrate of claim 3, wherein the thickness of the substantially rigid polystyrene core is about 0.25 inches.

6. The printing substrate of claim 1, wherein the grooves have been cut into the bottom layer with a computer numeric control cutter.

7. The printing substrate of claim 1, wherein the grooves have been manually cut into the bottom layer.

8. The printing substrate of claim 1, wherein the digital imaging systems further include flatbed digital printers.

9. A printing substrate for use with digital imaging systems, comprising:
(a) a first layer, wherein the first layer further includes canvas or a canvas-like material suitable for receiving a printed image;
(b) a second layer, wherein the second layer is attached to the first layer, wherein the second layer further includes a material that is different than the material of the first layer, and wherein the second layer is operative to provide structural support to the first layer;
(c) wherein, optionally, the first and second layers have been cut into a predetermined geometry that includes a central inner region and a plurality of outer regions surrounding the central inner portion; wherein the second layer of each of the outer regions includes at least three channels or grooves cut therein for allowing each outer region to be folded; and wherein the plurality of outer regions is operative to form a frame that is integral with the printing substrate when each outer region is folded over, inward, and onto the second layer and secured thereto.

10. The printing substrate of claim 9, wherein the first layer further includes low density polyethylene and binder having a thickness of about 0.75 mil; 16-18 pt base paper; and ethylene vinyl acetate having a thickness of about 1.25 mil.

11. The printing substrate of claim 9, wherein the second layer further includes a substantially rigid polystyrene core.

12. The printing substrate of claim 11, wherein the thickness of the substantially rigid polystyrene core is about 0.25 inches.

13. The printing substrate of claim 9, wherein the grooves have been cut into the second layer with a computer numeric control cutter.

14. The printing substrate of claim 9, wherein the grooves have been manually cut into the second layer.

15. The printing substrate of claim 9, wherein the digital imaging systems further include flatbed digital printers.

16. A printing substrate for use with digital flatbed imaging systems, comprising:
(a) a first layer, wherein the first layer further includes canvas or a canvas-like material;
(b) a second layer, wherein the second layer is attached to the first layer, wherein the second layer further includes a material that is different than the material of the first layer and that is operative to provide structural support to the first layer, and wherein the material of the second layer further includes foamboard;
(c) wherein the first and second layers have been cut into a predetermined geometry that includes a central inner region and a plurality of outer regions surrounding the central inner portion; wherein the second layer of each of the outer regions includes at least three grooves or channels cut therein for allowing each outer region to be folded; and wherein the plurality of outer regions is operative to form a frame that is integral with the printing substrate when each outer region is folded over, inward, and onto the second layer and secured thereto.

17. The printing substrate of claim 16, wherein the first layer further includes low density polyethylene and binder having a thickness of about 0.75 mil; 16-18 pt base paper; and ethylene vinyl acetate having a thickness of about 1.25 mil.

18. The printing substrate of claim 16, wherein the foamboard further includes a substantially rigid polystyrene core.

19. The printing substrate of claim 18, wherein the thickness of the substantially rigid polystyrene core is about 0.25 inches.

20. The printing substrate of claim 16, wherein the grooves have been cut into the second layer with a computer numeric control cutter.
